(19) United States
(12) Patent Application Publication
(10) Pub. No.: US 2004/0039991 A1
(43) Pub. Date: Feb. 26, 2004

(54) System, method, and computer program product in a data processing system for dynamic variable definition within an input form

(75) Inventors: Kenneth Marshall Hopkins, Round Rock, TX (US); Thomas Girard Lendacky, Austin, TX (US); David Raymond Posh, Cedar Park, TX (US); Kurt Russell Taylor, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 10/227,519

(22) Filed: Aug. 22, 2002

(51) Int. Cl. G06F 17/24

(52) U.S. Cl. 715/507

(57) ABSTRACT

A system, method, and computer program product are disclosed for dynamically generating code within a server computer system to process contents input into an input field in a form. The client computer system receives contents that are input into an input field that is included within the form. The input field has been defined using a descriptor variable. A definition of this descriptor variable is defined within the form. The form, including the definition of the descriptor variable, is transmitted from the client computer system to the server computer system. The server computer system then dynamically generates code to process the contents entered into the input field utilizing the definition of the descriptor variable that was included in the form.

### BACKGROUND OF THE INVENTION

1. Technical Field

The present invention relates generally to the field of data processing systems and, more specifically to a system, method, and computer program product in a data processing system for defining variables within a form itself so that a server computer system can use these definitions to dynamically generate code upon the receipt of the form in order to process the form.

2. Description of Related Art

The Internet, also referred to as an “internetwork”, is a set of computer networks, possibly dissimilar, joined together by means of gateways that handle data transfer and the conversion of messages from the sending network to the protocols used by the receiving network (with packets if necessary). When capitalized, the term “Internet” refers to the collection of networks and gateways that use the TCP/IP suite of protocols. The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies, such as the Internal Revenue Service and secretaries of state, which must interact with virtually all segments of society. Providing informational guides and/or searchable databases of online public records may reduce operating costs.

A user may access an Internet site to view or obtain information. A user, using a client computer system, may access an Internet site that is maintained by a server computer system. A browser, running on the client, contacts the server computer system that is managing the particular site. The server then transmits information to the client. This information is displayed to the user on the client by the browser using a page that adheres to Hypertext Markup Language (HTML).

Often these pages contain forms used to collect information from the user. These forms include one or more input fields. A user may then enter contents into these fields.

When a user has entered contents into an HTML form, the client transmits the completed form back to the server which then must process the received contents. In the prior art, the server must know, in advance of receiving a completed form, what fields are included in the form, the names of these fields, what possible entries may be made into the form's fields, and how to process each possible form entry. Software code must already be written and stored in the server for each possible form in order to process that form. Thus, input handling code must exist within the server for each form, each form variable, and each variable's possible value. This results in extensive redundancy from a code management perspective.

Therefore, a need exists for a method, system, and computer program product for defining variables within a form itself so that a server computer system can use the definitions it receives within the form itself to dynamically generate code to process the form, where the code is generated by the server in response to each receipt of a form and is not generated before the receipt of the form.

### SUMMARY OF THE INVENTION

A system, method, and computer program product are disclosed for dynamically generating code within a server computer system to process contents input into an input field in a form. The client computer system receives contents that are input into an input field that is included within the form. The input field has been defined using a descriptor variable. A definition of this descriptor variable is defined within the form. The form, including the definition of the descriptor variable, is transmitted from the client computer system to the server computer system. The server computer system then dynamically generates code to process the contents entered into the input field utilizing the definition of the descriptor variable that was included in the form.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation which depicts a data processing system in accordance with the present invention;

FIG. 2 illustrates a block diagram of a computer system which may be utilized as a server computer system in accordance with the present invention;

FIG. 3 depicts a block diagram of a computer system which may be utilized as a client computer system in accordance with the present invention;

FIG. 4 is a pictorial representation of a form that includes multiple input fields in accordance with the present invention;

FIG. 5 depicts a high level flow chart which illustrates creating a form that includes descriptor variables defined within the form itself which are used to define input fields in the form in accordance with the present invention;

FIG. 6 illustrates a high level flow chart which depicts a client computer system receiving contents input into a form that includes descriptor variables to define the form's input fields where definitions of the descriptor variables are also included within the form in accordance with the present invention;

FIG. 7 depicts a high level flow chart which illustrates a server computer system using descriptor variables defined within an input form to dynamically generate code to process the contents of the input fields of the input form in accordance with the present invention; and

FIGS. 8A and 8B illustrate software code for generating an HTML form that includes descriptor variables defined within the form in accordance with the present invention.

### DETAILED DESCRIPTION OF THE PREFERRED EMBODIMENT

A preferred embodiment of the present invention and. its advantages are better understood by referring to the figures, like numerals being used for like and corresponding parts of the accompanying figures.

The present invention is a system, method, and computer program product for dynamically generating code within a server computer system to process contents input into an input field in a form. The data processing system includes a server and a client computer system that are coupled together.

A user may design a form for gathering data. The form includes one or more input fields. Descriptor variables are used to define the input fields. A definition of each descriptor variable is included in the form itself. When the server receives a form and the contents entered into the form, the server will also receive the definitions of the descriptor variables. The descriptor variables and the definitions of the descriptor variables are hidden. The server will use the descriptor variables in order to dynamically generate code which will then be used by the server to process the form. In this manner, code is generated by the server in response to each receipt of a form in order to process the form and is not generated before the receipt of the form.

FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. Network 102 may include permanent connections, such as wire or fiber optic cables, or temporary connections made through telephone connections. The communications network 102 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device may be connected directly to a server 104 without departing from the scope of the present invention. Moreover, as used herein, communications include those enabled by wired or wireless technology.

Clients 108, 110, and 112 may be, for example, personal computers, portable computers, mobile or fixed user stations, workstations, network terminals or servers, cellular telephones, kiosks, dumb terminals, personal digital assistants, two-way pagers, smart phones, information appliances, or network computers. For purposes of this application, a network computer is any computer, coupled to a network, which receives a program or other application from another computer coupled to the network.

In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

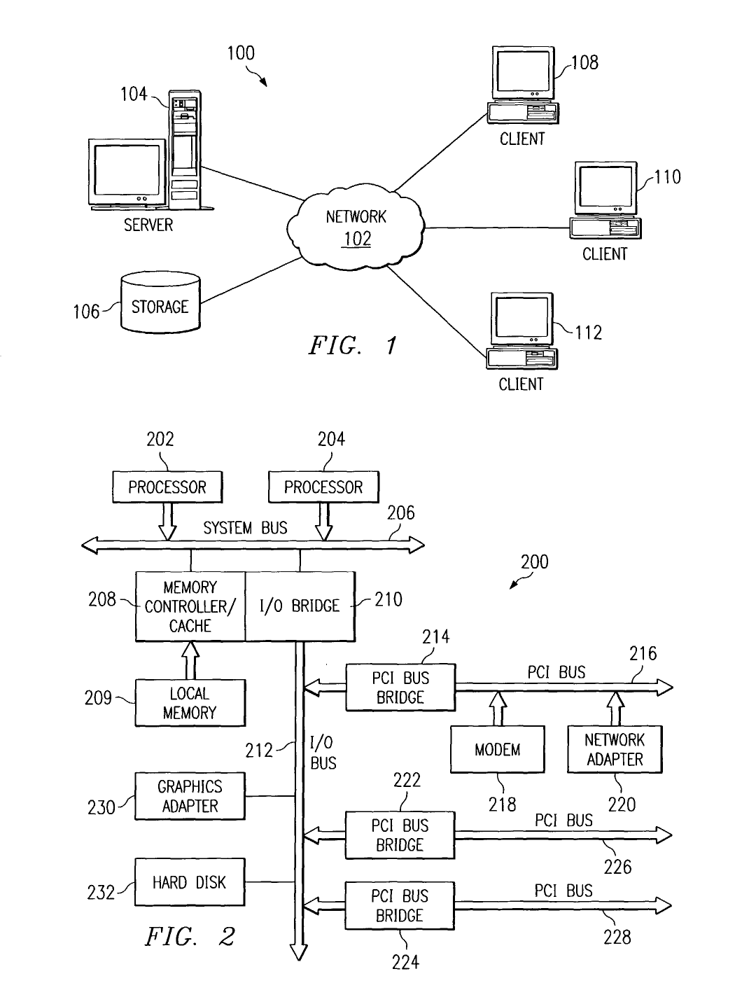

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

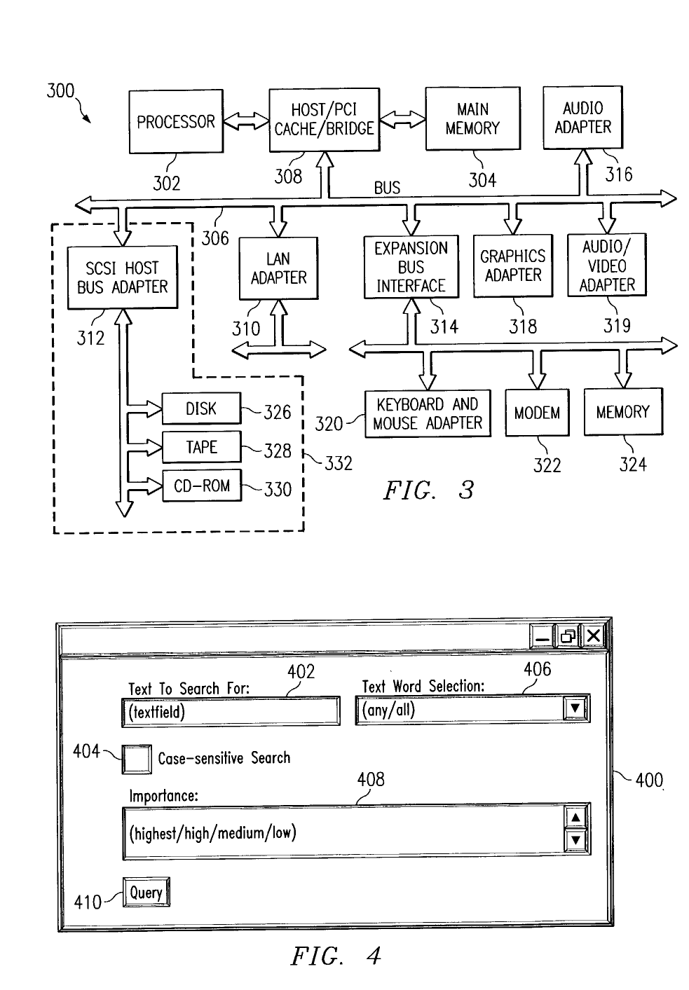

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

FIG. 4 is a pictorial representation of a form 400 that includes multiple input fields in accordance with the present invention. Form 400 includes a text search input field 402, a case sensitive check box 404, a text field select field 406, an importance field 408, and a query field 410 used to submit form 400.

Text search input field 402 is a dynamic freeform text input field. An input of any text of varying length is a valid text field input, depicted as “(textfield)”.

Case sensitive check box 404 modifies the search by indicating whether the search should be case sensitive. The input to case sensitive check box 404 is either a selection of the check box or the lack of a selection of the check box. Text field select field 406 is used to indicate whether the search is to be conducted looking for either any or all of the words entered into text search input field 402.

A first descriptor variable “TEXTFIELD” is used to define text search input field 402, case sensitive check box 404, and text field select field 406. Case sensitive check box 404 and text field select field 406 both modify the search for the terms entered into text search input field 402 and are thus all defined using a single descriptor variable.

Importance field 408 is a static field which permits a user to select one of the following choices: highest, high, medium, or low. A second descriptor variable “IMPORTANCE” is used to define importance field 408.

A third descriptor variable, “SUBMIT”, is also defined. The “SUBMIT” descriptor variable defines the query field 410 field to submit the form when query field 410 is selected.

A definition of each of these three descriptor variables is included in the form itself. The definition and the descriptor variables are included in the form as hidden variables. Thus, the input fields are defined in the form using descriptor variables. A definition of each descriptor variable is also included in the form. In this manner, the server can use the definitions of the descriptor variables in order to generate code to process the form.

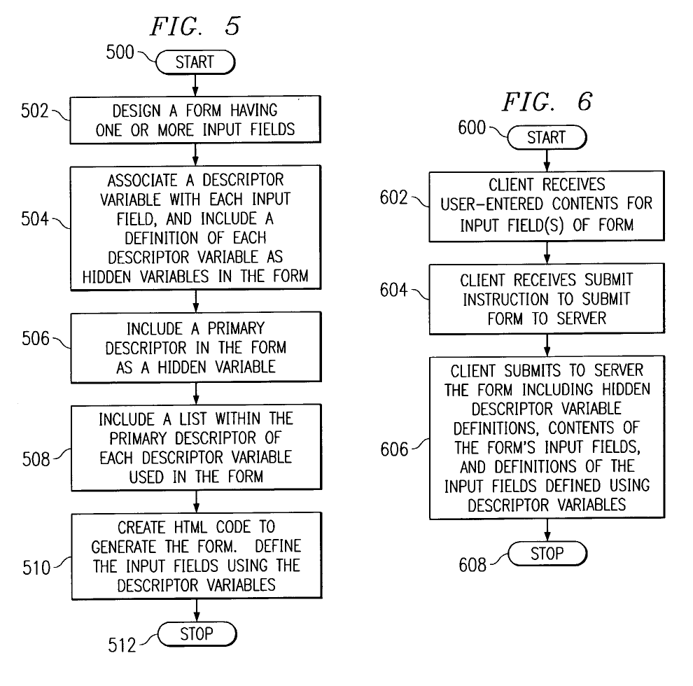

FIG. 5 depicts a high level flow chart which illustrates creating a form that includes descriptor variables defined within the form itself which are then used to define input fields in the form in accordance with the present invention. The process starts as depicted by block 500 and thereafter passes to block 502 which illustrates designing a form. The form is preferably an HTML form although the present invention may be used in other types of forms. The form includes one or more input fields. Next, block 504 depicts associating a descriptor variable with each input field. The descriptor variables are used to define these input fields. A definition of each descriptor variable is included in the form. The descriptor variables and definitions of the descriptor variables are included as hidden variables.

The process then passes to block 506 which illustrates defining a primary descriptor in the form. The primary descriptor is included as a hidden variable, and is used to list all of the descriptor variables that are defined within the form. Thereafter, block 508 depicts including a list within the primary descriptor of each descriptor variable used in the form. Next, block 510 illustrates creating HTML code to generate the form. The input fields are defined using the descriptor variables. A definition of each descriptor variable is included in the form itself. The process then terminates as depicted by block 512.

FIG. 6 illustrates a high level flow chart which depicts a client computer system receiving contents input into a form that includes descriptor variables to define the form's input fields where definitions of the descriptor variables are also included within the form in accordance with the present invention. The process starts as depicted by block 600 and thereafter passes to block 602 which illustrates a client computer system receiving contents entered into input fields of a form. Next, block 604 depicts the client receiving a submit instruction to submit the form to a server. Block 606, then, illustrates the client submitting to the server the form. When the form is submitted, the descriptor variable definitions, the contents entered into the input fields, and the definitions of the input fields that were defined using the descriptor variables are all submitted as part of the form to the server. The process then terminates as depicted by block 608.

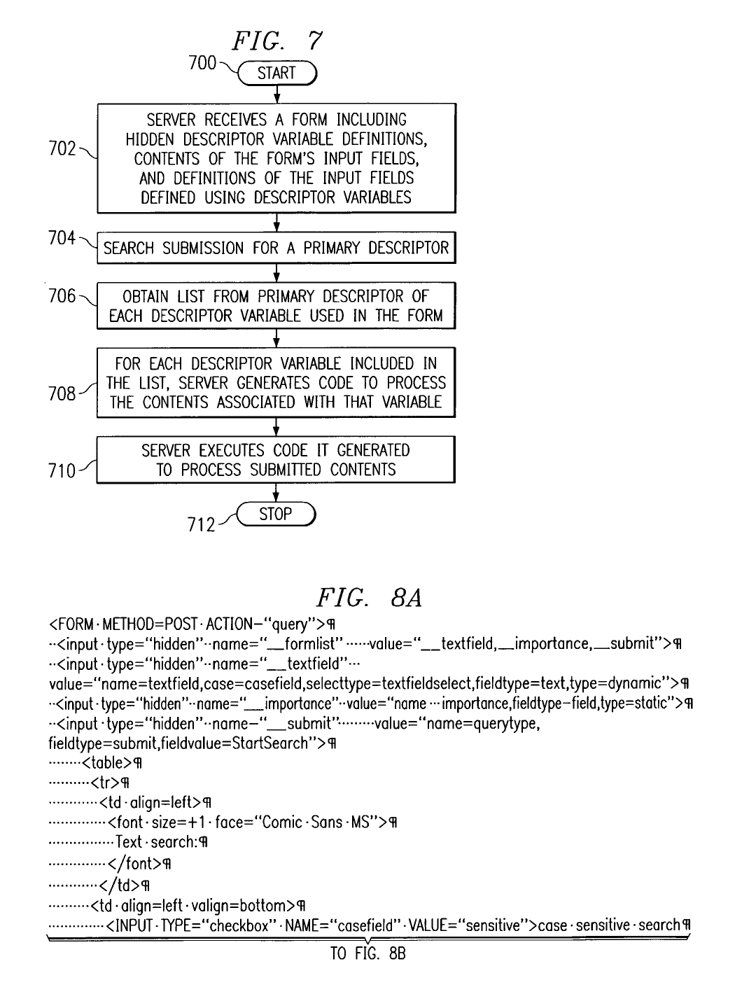

FIG. 7 depicts a high level flow chart which illustrates a server computer system using descriptor variables defined within an input form to dynamically generate code to process the contents of the input fields of the input form in accordance with the present invention. The process starts as depicted by block 700 and thereafter passes to block 702 which illustrates the server receiving a form that includes descriptor variable definitions, contents entered into the input fields of the form, and definitions of the input fields defined using the descriptor variables.

The process then passes to block 704 which depicts the server searching the form for a primary descriptor. Next, block 706 illustrates the server obtaining a list from the primary descriptor of descriptor variables. The list is a list of all of the descriptor variables that are used and defined within the form.

Thereafter, block 708 depicts the server dynamically generating code to process the form. The server generates the code in response to a receipt of the form. The server generates the code for a form each time the form is received. The server generates the form using the definitions of the descriptor variables that are used to define the input fields of the form. Next, block 710 illustrates the server processing the form by executing the code it generated. The process then terminates as depicted by block 712.

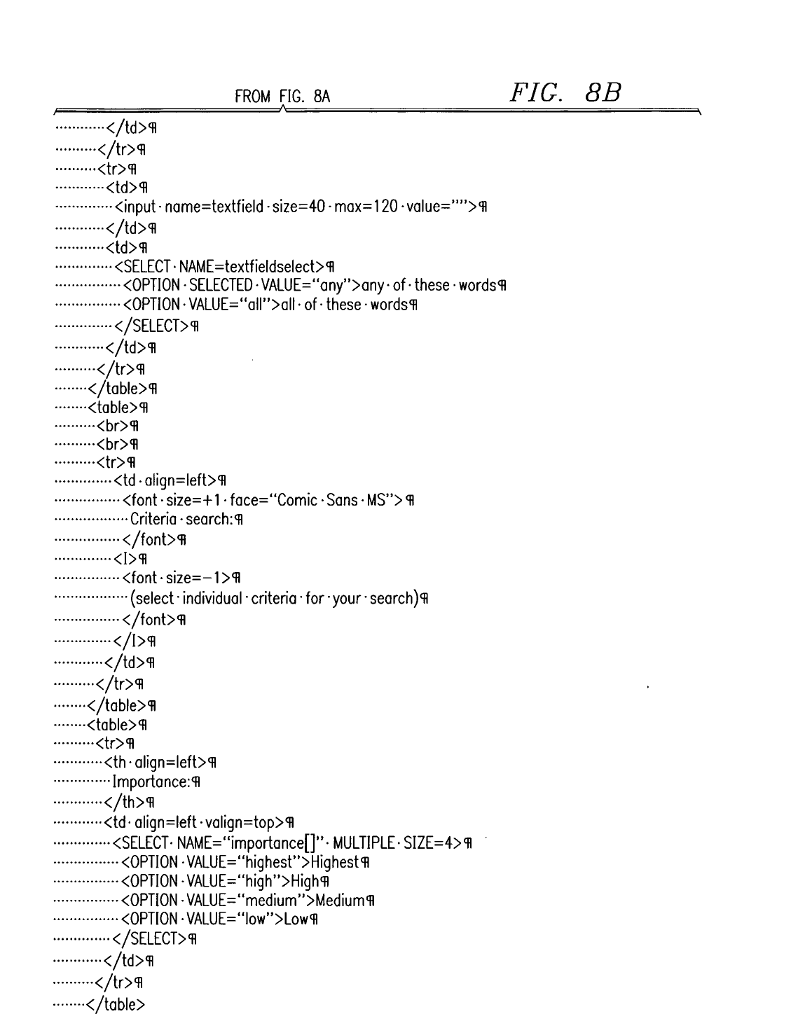

FIGS. 8A and 8B illustrate software code for generating an HTML form that includes descriptor variables defined within the form in accordance with the present invention.

The syntax of the primary descriptor is:

<input type=“hidden” name=“ . . . ” value=“_descriptor-1, _descriptor-2, _descriptor-n, . . . _submit”>

where “name” is _FORMLIST for the Primary Descriptor and “value” contains the names of the Descriptor variables themselves and terminates with the _SUBMIT Descriptor.

The syntax of a descriptor variable is:

<input type=“hidden” name=“(_descriptor-(1 . . . n) | _submit)” value=“descriptor_tag=tag_value”

The descriptor tag may include, but is not limited to the following:

| | |
|---|---|
| NAME: | the name of the Primary Descriptor, the |
| | Descriptor variables and the associated primary form |
| | variables that are being identified. |
| CASE: | the name of a case-sensitive primary form |
| | variable. |
| SELECTTYPE: | the name of a boolean primary form |
| | variable ( {checkbox, radio-button, etc.} defines |
| | whether to use ANY or ALL variable values. |
| FIELDTYPE: | the type of field being identified, either |
| | TEXT, FIELD or SUBMIT. |
| TYPE: | the type of variable being identified, either |
| | STATIC (predefined) or DYNAMIC (text-entry). |
| FIELDVALUE: | the value assigned by the form to the |
| | variable when checked/clicked/selected. |

Other Descriptor Tag entities can be defined and implemented to suit the needs of the form processor's logic, such as a ‘LITERALSTRING’ attribute that would treat an incoming DYNAMIC TEXT primary form variable as a literal, case-sensitive string. Likewise, the _SUBMIT Descriptor could contain a RESULTSFMT=value where the value might identify a selectable format to return the results in, such as XML, TEXT, HTML, etc.

In the example depicted in FIGS. 8A and 8B, “FORMLIST” is the primary descriptor and includes a list of the three descriptor variables. The three descriptor variables are “TEXTFIELD”, “IMPORTANCE”, and “SUBMIT”. This example produces the form shown in FIG. 4 and will process the contents received within the form's input fields.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system including a server computer system and a client computer system coupled together, said method comprising the steps of:
receiving within said client computer system contents input into an input field that is included within a form;
defining said input field using a descriptor variable;
including a definition of said descriptor variable within said form;
transmitting said form, including said definition of said descriptor variable, from said client computer system to said server computer system; and
dynamically generating code within said server computer system utilizing said definition of said descriptor variable to process said contents, wherein said code is generated only in response to a receipt of said form and is not generated before said receipt.

2. The method according to claim 1, further comprising the steps of:
including said descriptor variable as a hidden variable within said form.

3. The method according to claim 1, further comprising the steps of:
including within said form a plurality of input fields;
defining said plurality of input fields with a plurality of descriptor variables; and
including within said form a definition of each one of said plurality of descriptor variables.

4. The method according to claim 3, further comprising the steps of:
including a primary descriptor within said form; and
including within said primary descriptor a list of said plurality of descriptor variables.

5. The method according to claim 4, further comprising the steps of:
determining, upon a receipt of a second form by said server computer system, whether said second form includes a primary descriptor; and
in response to a determination that said second form includes a primary descriptor, utilizing said primary descriptor by said server computer system to generate code to process said second form.

6. The method according to claim 5, further comprising the steps of:
utilizing said primary descriptor by said server computer system to identify each one of said plurality of descriptor variables; and
generating code for each one of said plurality of descriptor variables to process contents received in input fields defined utilizing said plurality of descriptor variables.

7. A data processing system including a server computer system and a client computer system coupled together, comprising:
said client computer system receiving contents input into an input field that is included within a form;
a descriptor variable for defining said input field;
a definition of said descriptor variable being included within said form;
said form, including said definition of said descriptor variable, being transmitted from said client computer system to said server computer system; and
said server computer system dynamically generating code utilizing said definition of said descriptor variable to process said contents, wherein said code is generated only in response to a receipt of said form and is not generated before said receipt.

8. The system according to claim 7, further comprising:
said descriptor variable being included as a hidden variable within said form.

9. The system according to claim 7, further comprising:
a plurality of input fields being included within said form;
said plurality of input fields being defined using a plurality of descriptor variables; and
a definition of each one of said plurality of descriptor variables being included in said form.

10. The system according to claim 9, further comprising:
a primary descriptor being included within said form; and
a list of said plurality of descriptor variables being included within said primary descriptor.

11. The system according to claim 10, further comprising:
said server computer system for determining, upon a receipt of a second form by said server computer system, whether said second form includes a primary descriptor; and
in response to a determination that said second form includes a primary descriptor, said server computer system utilizing said primary descriptor to generate code to process said second form.

12. The system according to claim 11, further comprising:
said primary descriptor being utilized by said server computer system to identify each one of said plurality of descriptor variables; and
said server computer system generating code for each one of said plurality of descriptor variables to process contents received in input fields defined utilizing said plurality of descriptor variables.

13. A computer program product in a data processing system including a server computer system and a client computer system coupled together, said product comprising:
instruction means for receiving within said client computer system contents input into an input field that is included within a form;
instruction means for defining said input field using a descriptor variable;
instruction means for including a definition of said descriptor variable within said form;
instruction means for transmitting said form, including said definition of said descriptor variable, from said client computer system to said server computer system; and
instruction means for dynamically generating code within said server computer system utilizing said definition of said descriptor variable to process said contents, wherein said code is generated only in response to a receipt of said form and is not generated before said receipt.

14. The product according to claim 13, further comprising:
instruction means for including said descriptor variable as a hidden variable within said form.

15. The product according to claim 13, further comprising:
instruction means for including within said form a plurality of input fields;
instruction means for defining said plurality of input fields with a plurality of descriptor variables; and
instruction means for including within said form a definition of each one of said plurality of descriptor variables.

16. The product according to claim 15, further comprising:
instruction means for including a primary descriptor within said form; and
instruction means for including within said primary descriptor a list of said plurality of descriptor variables.

17. The product according to claim 16, further comprising:
instruction means for determining, upon a receipt of a second form by said server computer system, whether said second form includes a primary descriptor; and
in response to a determination that said second form includes a primary descriptor, instruction means for utilizing said primary descriptor by said server computer system to generate code to process said second form.

18. The product according to claim 17, further comprising:
instruction means for utilizing said primary descriptor by said server computer system to identify each one of said plurality of descriptor variables; and
instruction means for generating code for each one of said plurality of descriptor variables to process contents received in input fields defined utilizing said plurality of descriptor variables.
